(19) United States
(12) Patent Application Publication
(10) Pub. No.: US 2013/0309536 A1
(43) Pub. Date: Nov. 21, 2013

(54) HOUSING STRUCTURE FOR HOLDING A PLURALITY OF SQUARE SECONDARY BATTERIES

(71) Applicant: Donald P.H. WU, Hsinchu County (TW)

(72) Inventor: Donald P.H. WU, Hsinchu County (TW)

(21) Appl. No.: 13/476,238

(22) Filed: May 21, 2012

(51) Int. Cl. H01M 2/10

(52) U.S. Cl. 429/99

(57) ABSTRACT

A housing structure for holding square secondary batteries is provided with a first and a second assembling surfaces which are formed with a plurality of receiving grooves and ribs, the receiving grooves are aligned in pairs in such a manner that a receiving space is defined between every pair of receiving grooves, a deformation space is defined between every pair of ribs, and the batteries are received in the receiving spaces. The distance between a lateral surface of a square secondary battery and an opposite lateral surface of a neighboring square secondary battery equals a width of the deformation space, a distance between two lateral surfaces of a same square secondary battery is defined as a thickness of the square secondary battery, and the width of the deformation space is greater than or equal to ⅖ of the thickness of the square secondary battery.

### BACKGROUND OF THE INVENTION

1. Field of the Invention

The present invention relates to a housing, and more particularly to a housing structure for holding a plurality of square secondary batteries.

2. Description of the Prior Art

Referring to FIG. 1, a plurality of conventional square secondary batteries 10 is disposed in a housing 11 in such a manner that the square secondary batteries 10 are located closely against one another. Such arrangements can improve space utilization, further can prevent the problem that the square secondary batteries 10 are likely to move in an uncontrollable manner and consequently causing short circuit, when there is too much space between the batteries 10.

It is to be noted that when there is external or internal short circuit fault in the batteries, the square secondary batteries 10 will inflate. Hence, the lateral sides of the square secondary batteries 10 are designed as deformation surfaces 12 to release inner pressure of the batteries in case of faults. However, as shown in FIG. 2, when faults occur in the closely arranged square secondary batteries 10, the inflated deformation surfaces 12 of the fault battery will push against the neighboring square secondary battery 101, and cause damage to other square secondary batteries 10.

The present invention has arisen to mitigate and/or obviate the afore-described disadvantages.

### SUMMARY OF THE INVENTION

The primary object of the present invention is to provide a housing structure for holding a plurality of square secondary batteries, wherein the width A of a deformation space of the housing is designed to be equal to or larger than ⅖ of the thickness B of the square secondary batteries, namely, A≧⅖B. Therefore, even if faults cause the two neighboring square secondary batteries to inflate simultaneously, the width of the deformation space is wide enough to absorb the inflation of the two neighboring square secondary batteries, thus preventing the rest square secondary batteries from being affected.

### BRIEF DESCRIPTION OF THE DRAWINGS

FIG. 1 shows a conventional housing structure for holding a plurality of square secondary batteries;

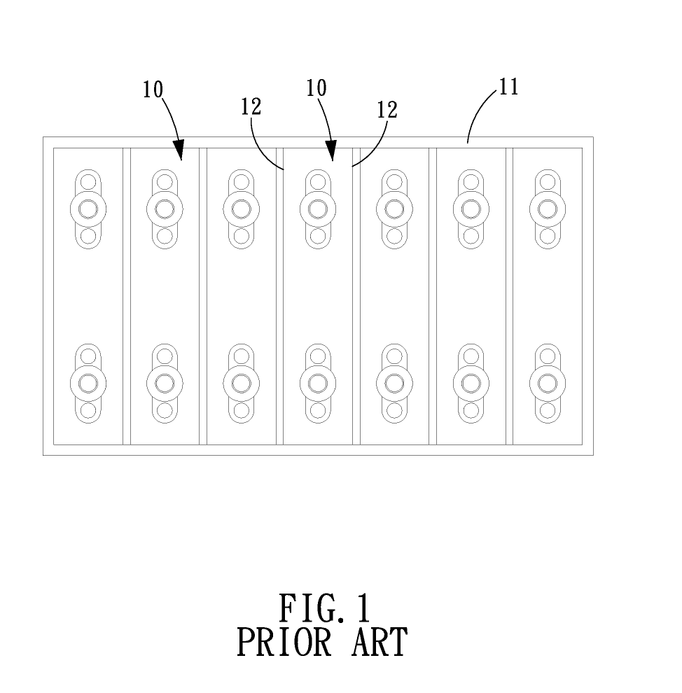

FIG. 2 shows that one of the batteries of FIG. 1 inflates;

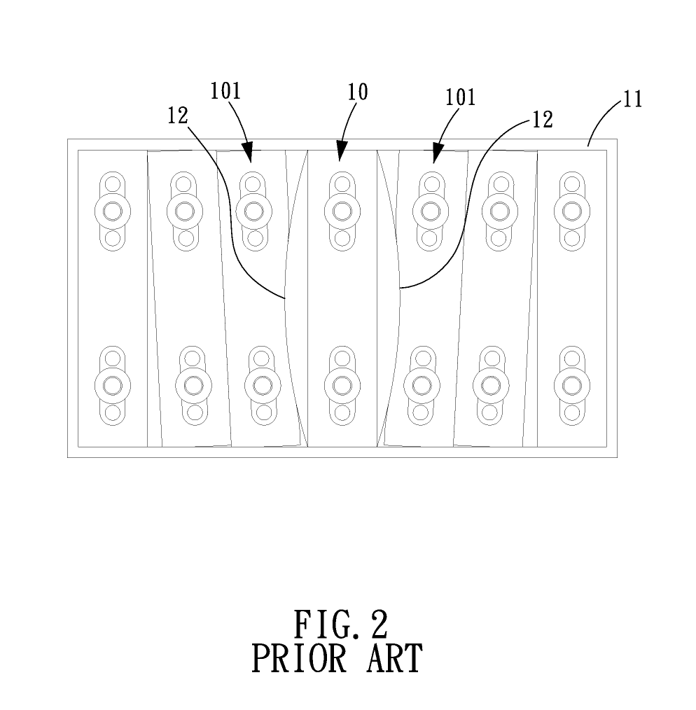

FIG. 3 is an exploded view of a housing structure for holding a plurality of square secondary batteries in accordance with the present invention;

FIG. 4 is an assembly plan view of the housing structure for holding a plurality of square secondary batteries in accordance with the present invention; and

FIG. 5 shows that two of the batteries of FIG. 4 inflate simultaneously.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

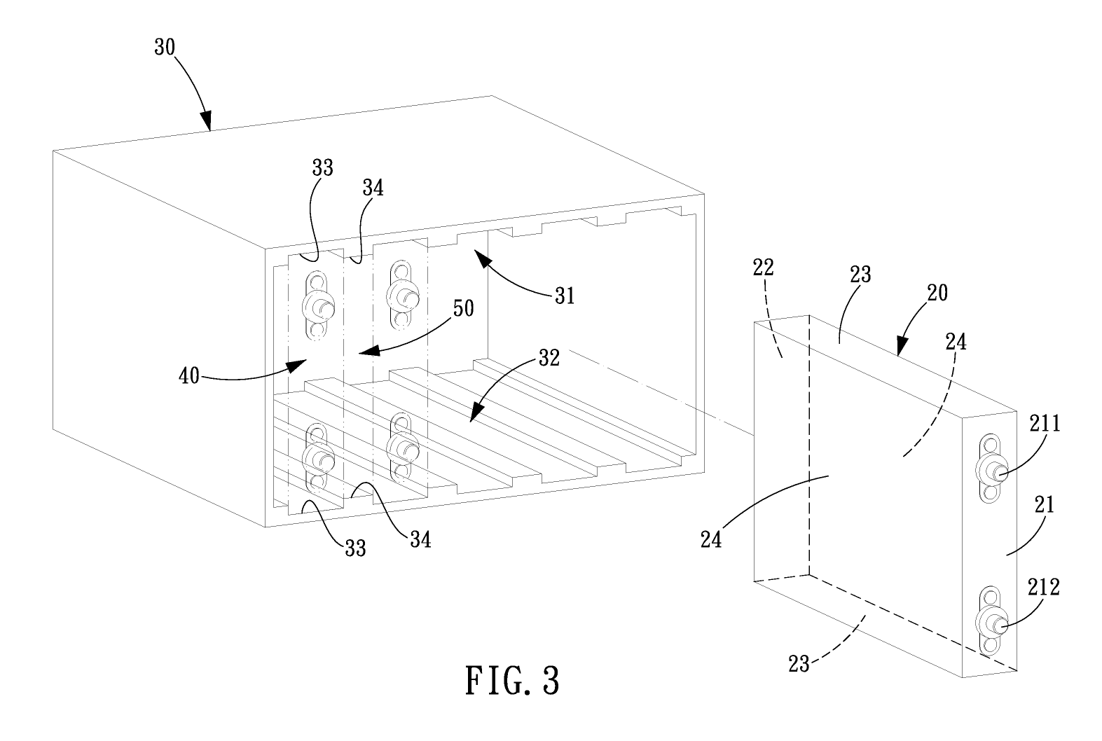

Referring to FIG. 3, a housing structure 30 for holding a plurality of square secondary batteries 20 is shown.

Each of the square secondary batteries 20 is a rectangular structure with a top surface 21 formed at one end thereof and a bottom surface 22 at another end. The top surface 21 is provided with a positive terminal 211 and a negative terminal 212, and between the bottom surface 22 and the top surface 21 are disposed two opposite lateral surfaces 23 and two opposite deformation surfaces 24.

The housing structure 30 is formed with an inner space in which being formed a first assembling surface 31 and an opposite second assembling surface 32. On each of the first and second assembling surfaces 31, 32 are provided a plurality of receiving grooves 33 and ribs 34 arranged in an alternative manner. The receiving grooves 33 of the first assembling surface 31 are aligned to the receiving grooves 33 of the second assembling surface 32 in pairs in such a manner that the rectangular space defined between every pair of receiving grooves 33 (the pair of receiving grooves means one receiving groove 33 in the first assembling surface 31 and the other in the second assembling surface 31) is defined as a receiving space 40, and the rectangular space defined between every pair of ribs 34 (one in the first assembling surface 31 and the other in the second assembling surface 32) is defined as a deformation space 50. The respective rectangular secondary batteries 20 are received in the receiving spaces 40 in such a manner that the two lateral surfaces 23 are received in the two receiving grooves 33.

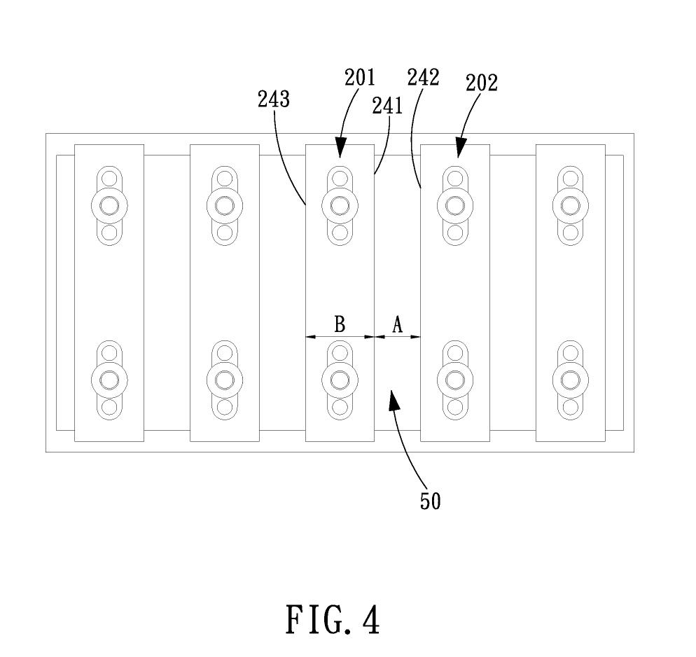

Referring to FIG. 4, the distance between the deformation surfaces 241 and 242 of two neighboring square secondary batteries 201 and 202 is defined as being equal to a width A of the deformation space 50. The distance between two deformation surfaces 241 and 243 of the square secondary battery 201 is defined as the thickness B of the square secondary battery 20. The width A of the deformation space 50 is equal to or larger than ⅖ of the thickness B of the square secondary battery 20, namely, A ⅖B.

For a better understanding of the present invention, its operation and function, reference should be made to FIG. 3 again, the respective square secondary batteries 20 are disposed in the receiving spaces 40 of the housing structure 30 in such a manner that the lateral surfaces 23 of the square secondary batteries 20 are disposed in the receiving grooves 33. It is to be noted that the square secondary batteries 20 are restricted and firmly hold by the ribs 34 and thus can be prevented from undesired movement.

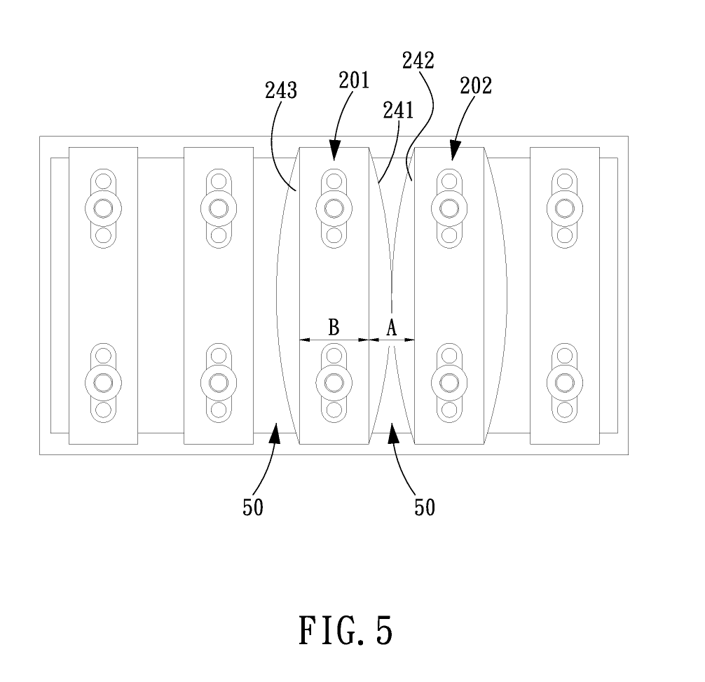

Referring then to FIG. 5, in case that there is a fault causing two neighboring square secondary batteries 201, 202 to inflate, one deformation surface 241 of the square secondary battery 201, after inflation, will protrude outward a distance which is approximately ⅕ of the thickness B of the square secondary battery 201. The width A of the deformation space 50 is greater than or equal to ⅖ of the thickness B of the square secondary battery 20, therefore, even if faults cause the two neighboring square secondary batteries 201, 202 to inflate simultaneously, the width A of the deformation space 50 is wide enough to absorb the inflation of the two neighboring square secondary batteries 201, 202, thus preventing the rest square secondary batteries from being affected.

While we have shown and described various embodiments in accordance with the present invention, it is clear to those skilled in the art that further embodiments may be made without departing from the scope of the present invention.

What is claimed is:

1. A housing structure for holding a plurality of square secondary batteries, each of the square secondary batteries being a rectangular structure with a top surface and formed at one end thereof and a bottom surface at another end, the top surface being provided with a positive terminal and a negative terminal, and between the bottom surface and the top surface being disposed two opposite lateral surfaces and two opposite deformation surfaces, the housing structure being formed with an inner space in which being formed a first assembling surface and an opposite second assembling surface, on each of the first and second assembling surfaces being provided a plurality of receiving grooves and ribs arranged in an alternative manner, the receiving grooves of the first assembling .surface being aligned to the receiving grooves of the second assembling surface in pairs in such a manner that a rectangular space defined between every pair of receiving grooves is defined as a receiving space, and the rectangular space defined between every pair of ribs is defined as a deformation space, the respective rectangular secondary batteries being received in the receiving spaces in such a manner that the two opposite lateral surfaces are received in the two receiving grooves; the housing structure being characterized in that:
a distance between two deformation surfaces of two neighboring square secondary batteries is defined as being equal to a width of the deformation space, a distance between two lateral surfaces of a same square secondary battery is defined as a thickness of the square secondary battery, and the width of the deformation space is greater than or equal to ⅖ of the thickness of the square secondary battery.
